(19) United States
(12) Patent Application Publication
(10) Pub. No.: US 2011/0179958 A1
(43) Pub. Date: Jul. 28, 2011

(54) SUBSTRATE PUNCH ASSEMBLY

(76) Inventor: Bruce JOHNSON, LaCenter, WA (US)

(21) Appl. No.: 12/693,974

(22) Filed: Jan. 26, 2010

(51) Int. Cl. B41F 19/02; B23D 25/12; B23D 33/00

(52) U.S. Cl. 101/26; 83/345; 83/117; 83/37

(57) ABSTRACT

Substrate punch assembly, comprising a punch for perforating a substrate, a resilient element provided next to the punch, and a die arranged opposite to the punch for pressing against the substrate in the direction of the punch during a punch action, wherein the resilient element is configured to at least partly move with respect to the punch for pushing the substrate away from the punch when the punch moves away from the die.

### BACKGROUND OF THE INVENTION

At present, printers may be equipped with punches for providing perforations in paper while processing and/or printing the paper. Such printers may output pre-perforated hardcopies. A problem that sometimes occurs in these printers is that the punch gets stuck in the paper while the paper is being moved through the printer for printing. This causes tearing of the paper, or the paper may get stuck in the printer. Such problems may for example occur due to speed variations between the punch and the paper.

Especially relatively heavy papers weighing 120 gram per square meter or more tend to get stuck. These relatively heavy paper materials do not strip well off the punch.

To better control the punch process in a printer, the punch mechanism is usually arranged along a straight portion of the paper path. However, this increases the size of the printer.

It is therefore an object of the invention to provide for an alternative substrate punch mechanism.

### BRIEF DESCRIPTION OF THE DRAWINGS

For the purpose of illustration, certain embodiments of the present invention will now be described with reference to the accompanying diagrammatic drawing(s), in which:

FIG. 1 shows a perspective view of a substrate punch assembly;

FIG. 2 shows a diagrammatic drawing of a top view of a substrate punch assembly and a part of a substrate;

FIG. 3 shows a diagrammatic sectional side view of the substrate punch assembly and substrate part of FIG. 2.

### DETAILED DESCRIPTION

In the following detailed description, reference is made to the accompanying drawings. The embodiments in the description and drawings should be considered illustrative and are not to be considered as limiting to the specific embodiment of element described. Multiple embodiments may be derived from the following description and/or drawings through modification, combination or variation of certain elements. Furthermore, it may be understood that also embodiments or elements that are not literally disclosed may be derived from the description and drawings by a person skilled in the art.

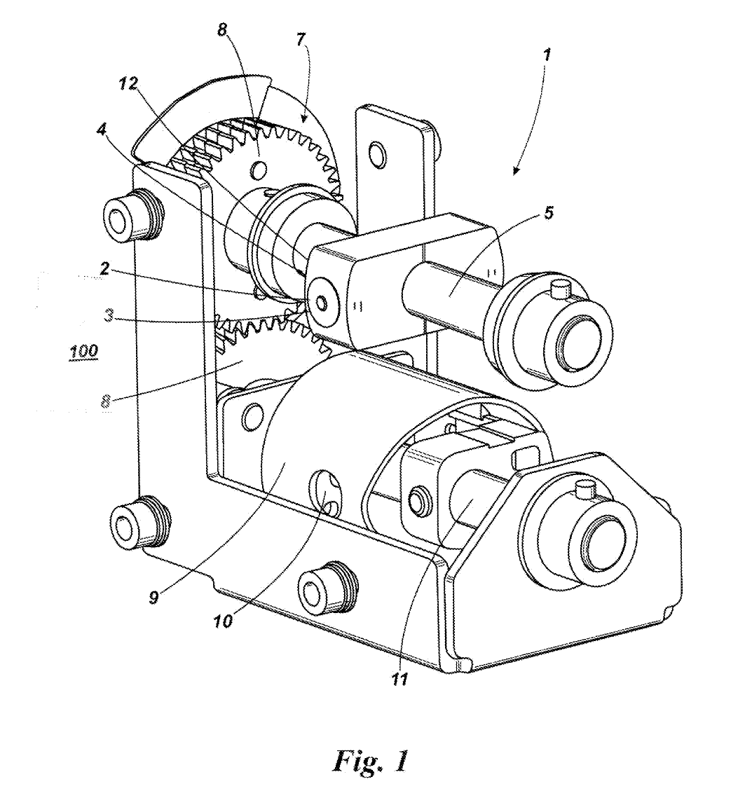

In FIG. 1-3 a substrate punch assembly 1 is shown. The assembly 1 comprises a punch 2 for perforating a substrate 6. The substrate 6 may comprise paper or any other printable media for delivering printed hard copies. The punch assembly 1 may be arranged in a printer 100, which may be any type of printer 100, such as, but not limited to, a laser printer, an LEP printer, an inkjet printer, for example thermo or piezo driven, a copying machine, etc. In an embodiment, the printer 100 may comprise an office printer arranged to print paper of up to approximately 30 centimeters of width.

The punch 2 may be provided with a circumferential cutting edge 3 that determines the size of the perforation to be punched in the substrate 6. The punch assembly 1 further comprises a resilient element 4. The resilient element 4 may be arranged around the punch 2, for example around a part or the entire circumference of the punch 2. At least a part of the resilient element 4 may consist of resilient material, for example elastomeric material such as, but not limited to, rubber. The resilient element 4 may be formed as a foot for the punch 2. In the shown embodiment, the entire foot of the punch 2 may be formed by resilient material such as, but not limited to, elastomeric material. In other embodiments, just a part of the foot consists of resilient material. The resilient element 4 may have a substrate facing part 12 for abutting the substrate 6 when punching that is arranged to move with respect to the cutting edge 3.

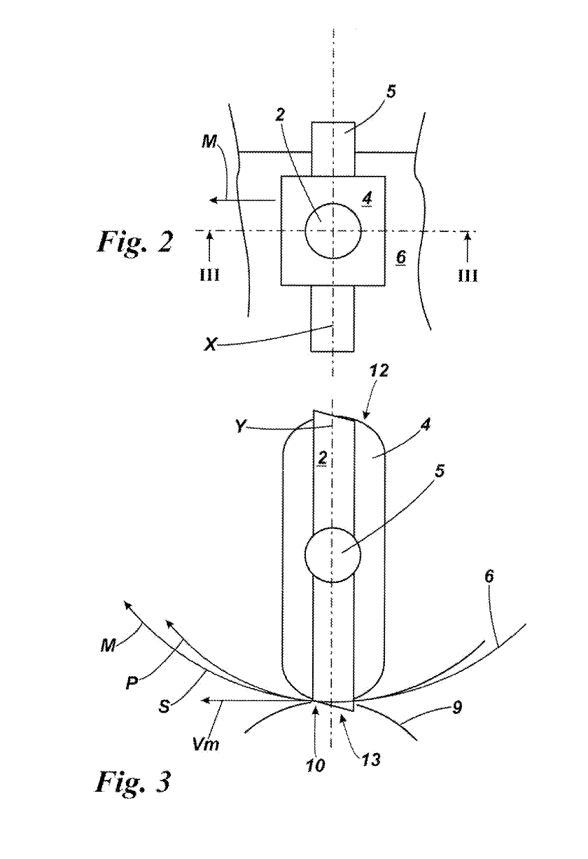

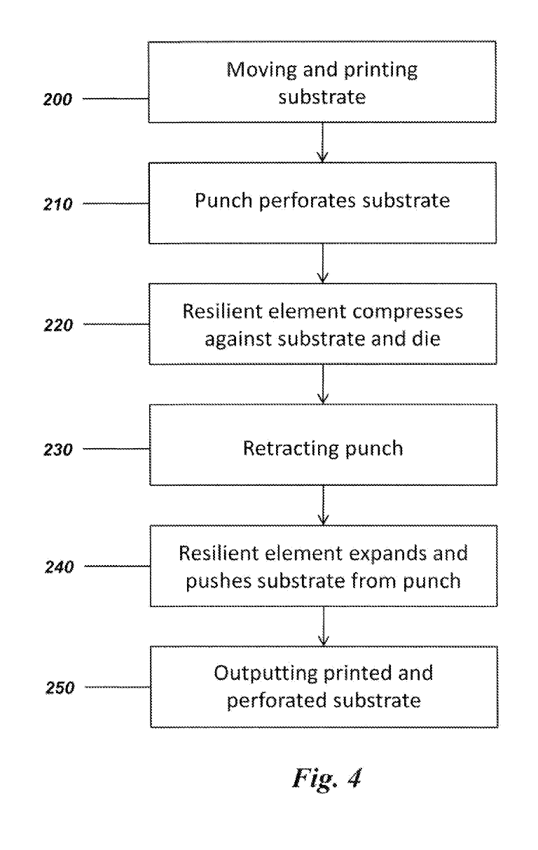

FIGS. 2 and 3 diagrammatically depict a punch 2 and resilient element 4 in top and side view, respectively. As shown in FIGS. 1-3, the punch assembly 1 may comprise a rotary punch 2, for moving towards a substrate 6 in a rotary manner. The punch 2 may be arranged to rotate around rotation axis X. The punch 2 may be fixed to a rotation axle 5 for rotation around the rotation axis X. The punch 2 and/or resilient element 4 may be directly fixed to the axle 5. The punch 2 and/or resilient element 4 may be held in place by friction between the outer surface of the punch 2 and the inner surface of the resilient element 4 that is enclosing the punch 2. The punch 2 and/or resilient element 4 may be arranged so that the position of the punch 2 and/or resilient element 4, respectively, along the length of the axle 5 may be adjusted. The rotation axis X and axle 5 may be arranged perpendicular to the direction of movement M of the substrate 6. The punch 2 may be arranged to rotate approximately in the direction of substrate movement M, for example along a curve P.

A substrate drive and guide mechanism may guide the substrate 6 along a predetermined substrate movement path S. The substrate drive and guide mechanism may also determine the velocity of the moving substrate 6. The substrate drive and guide mechanism may be provided with a substrate path sensor to sense the velocity and position of the substrate 6. A processor may be provided, that is arranged to control the velocity of the punch 2 in response to a signal coming from said substrate path sensor and a preset distance between subsequent perforations. The substrate path sensor and/or the processor may be arranged to send signals to the punch drive mechanism 7.

The substrate path S may comprise a curved portion, as is common in many printers. The substrate path S may for example be curved along an angle of at least 90°, or at least 135°, or approximately 180°, for example ranging from approximately 10° to approximately 180°, or approximately 90° to approximately 180°. The punch assembly 1 may be arranged to punch the substrate 6 in a curved portion of the substrate movement path S, as shown in FIG. 3. The punch assembly 1 may be arranged on the concave side of the substrate movement path S. The substrate path sensor may be arranged on the convex side of the substrate movement path S. In another embodiment, the punch assembly 1 may be arranged on the convex side of the substrate movement path S, and/or the substrate path sensor may be arranged on the concave side of the substrate movement path S

The punch assembly 1 may be provided with a die 9, opposite to the punch 2. The die 9 may be arranged for pressing against the substrate 6 in the direction of the punch 2 during a punch action. The die 9 may aid in compressing the resilient element 4 during a punch action. The die 9 may comprise a hole 10 for receiving the punch 2. The size of the hole 10 may correspond to the circumferential cutting edge 3 of the punch 2 so that the punch 2 fits in the hole 10. During a punching action, the resilient element 4 may press the substrate 6 against the die 9, while the punch 2 punches the substrate 6 and may temporarily extend partly in the hole 10 so that the substrate 6 is perforated. During the punching action, the resilient element 4 may be compressed. Pressing the substrate 6 against the die 9 during punching may facilitate easier and better punching and may hold the substrate 6 in place during perforation. After punching the resilient element 4 may expand to its original shape and thereby strip the substrate 6 from the punch 2. In this way, the resilient element 4 facilitates punching without damaging the substrate 6, even when there are differences in speed between the punch 2 and the substrate 6, and/or when punching a curved portion of the substrate 6, and/or when the punching a relatively heavy weight substrate 6, as will be further clarified below.

The punch assembly 1 may comprise a drive mechanism 7 for driving the punch 2 and the die 9. The drive mechanism 7 may comprise a transmission, provided with transmission elements 8. The transmission elements 8 may comprise gears, belts, wheels or the like, for example toothed gears. The transmission elements 8 may be arranged to rotate the punch 2 and the die 9 with respect to each other, for example at the same velocity, so that the punch 2 is guided into the hole 10 at each rotation. The drive mechanism 7 may drive the punch 2 independently of the substrate drive mechanism. The drive mechanism 7 may be arranged to drive the punch 2 at a variable velocity. For example, during one rotation of the punch 2, the velocity of the punch 2 may vary. The punch 2 may slow down and/or speed up between each punch action. The variable velocity may be determined by preset distances between subsequent perforations, and/or preset numbers of subsequent perforations in the substrate 6 and/or the velocity of the substrate 6. The punch 2 may accelerate just before the punch action.

The punch assembly 1 may be relatively space efficient. The resilient element 4 may allow for placing the punch 2 along a curved portion of the substrate movement path S, for example on the concave side of the path S. The drive mechanism 7 may be arranged next to the substrate movement path S, as seen from a direction perpendicular to a substrate 6 placed in the printer 100. The axle 5 may extend from the drive mechanism 7 into the inner portion of the substrate movement path S so that the punch 2 extends within said inner portion. Optionally, the axle 5 may be supported on the opposite side of the drive mechanism 7. The die 9 may be arranged on the convex side of the substrate movement path S, opposite to the punch 2. The die 9 may comprise a second axle 11, parallel to the axle 5 of the punch 2. The second axle 11 may be connected to a transmission element 8 on one end, and optionally a support on the other end, as shown in FIG. 1.

In another embodiment (not shown), the punch assembly 1 may be arranged near a straight portion of the substrate movement path, for punching a straight portion of the substrate 6.

The resilient element 4 may comprise elastomeric material such as rubber. The resilient element 4 may comprise a through hole through which the axle 5 extends. The resilient element 4 may comprise two blocks, each fixed to the axle 5 and/or the surface of the punch 2, and/or to each other, arranged on opposite sides of the axle 5. The punch 2 may be directly fixed to the axle 5 and/or to the resilient element 4.

The resilient element 4 of the punch assembly 1 may be provided next to the punch 2, so that during punching the resilient element 4 presses the substrate 6 against the die 9 while the punch 2 cuts through the substrate 6, and during retraction of the punch 2 with respect to the die 9, the resilient element 4 expands to its original size to push the substrate 6 away from the punch 2.

The punch 2 may comprise an undercut near the cutting edge 3. The undercut may be defined by the slightly tapering shape of the punch towards the cutting edge 3. The undercut may be formed to facilitate clearance of the punch 2 from the die 9 when a part of the punch 2 moves in and out of the die 9. The substrate 6 may have a tendency to stick to the punch 2 due to the undercut. When punching through the substrate 6, the friction between the punch 2 and the inner edge of the perforation may steadily increase due to the undercut, while the punch 2 moves through the substrate 6. Here, the resilient element 4 may aid in releasing the substrate 6 from the punch 2 by stripping the substrate 6 off the punch 2 due to expansion. By preventing that the substrate 6 sticks to the punch 2, jamming of the substrate 6 in the printer 100 and/or damaging the substrate 6 may be prevented.

While normally the speed difference between the punch 2 and the substrate 6 would have to be kept at a small value to prevent damage to the substrate 6, use of the resilient element 4 may allow for more margin between the speed of the punch 2 and the speed of the substrate 6. The punch assembly 1 does not necessarily need to be equipped with precision electronics or mechanics. The punch assembly 1 may be relatively cost efficient. The punch assembly 1 may have a relatively wide operating window, which may allow for relatively low cost and/or relatively low precision drive electronics and motors, and punch a relatively wide range of media thicknesses, weights and materials. In general, the punch assembly 1 may advantageous for application in a relatively wide range of printers and/or substrates 6.

The punch assembly 1 has shown to work advantageously on various paper weights and thicknesses. For example, the resilient element 4 has shown to efficiently strip paper having weights of approximately 120 grams per square meter or more.

In general, the punch 2 may have a velocity vector Vm parallel to the movement of the substrate 6 at a point of perforation 13. This is shown for the rotary punch 2 in FIG. 3, wherein Vm may be the velocity vector of both the punch 2 and the substrate 6 at a point of perforation 13. This point of perforation 13 may be approximately the point where a longitudinal axis Y of the rotary punch 2 is approximately perpendicular the velocity vector of the substrate 6 within the area of perforation, as shown in FIG. 3, e.g. the middle of the perforation. During perforation the end of the punch 2 may move in approximately the same direction as the substrate 6.

Instead of a rotary punch 2, the punch 2 may be a linear punch 2, moving up and down in a direction perpendicular to the substrate 6. Optionally, it may be advantageous to also move the punch 2 in direction Vm during punching to prevent damaging the substrate 6. During punching the linear punch 2 may be moved together with the substrate 6 along a predetermined path. Therefore, the linear punch 2 may also have a velocity vector Vm without rotating the punch 2.

In other embodiments, the resilient element 4 may comprise a helical spring member, for example arranged around and/or next to the punch 2. The punch assembly 1 may also be provided with other suitable resilient elements 4.

The punch assembly 1 may be conveniently applied by itself, not necessarily in a printer, or may be integrated in and/or connected to other products than printers.

In one aspect, a substrate punch assembly 1 may be provided, which may comprise (i) a punch 2 for perforating a substrate 6, (ii) a resilient element 4 provided next to the punch 2, and (iii) a die 9 arranged opposite to the punch 2 for pressing against the substrate 6 in the direction of the punch 2 during a punch action, wherein the resilient element 4 is configured to at least partly move with respect to the punch 2 for pushing the substrate 6 away from the punch 2 when the punch 2 moves away from the die 9.

In a second aspect, a method of punching a substrate 6 may be provided, as illustrated by the flow chart of FIG. 4. The method may comprise (i) moving a substrate 6 for printing, optionally while printing the substrate 6, as indicated by block 200, (ii) punching the substrate 6 with a punch 2, as indicated by block 210, (iii) compressing a resilient element 4 against the substrate 6, as indicated by block 220, and (iv) retracting the punch 2 from the substrate 6, as indicated by block 230, optionally while the resilient element 4 pushes the substrate 6 away from the punch 2 by expanding back to its original size, as indicated by block 240. With this method, a printed and perforated substrate 6 may be output by a printer 100, as indicated by block 250.

In a third aspect, a print system may be provided, comprising (i) a substrate guide mechanism for guiding the substrate 6 along a curved path S, (ii) a punch 2 for punching a perforation in a curved portion of the substrate 6, and (iii) a die 9 for receiving the punch 2, wherein the punch 2 may comprise a resilient element 4 arranged to push the substrate 6 in the direction of the die 9 adjacent to the perforation.

The above description is not intended to be exhaustive or to limit the invention to the embodiments disclosed. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, while a reference to a certain number of elements does not exclude the possibility of having more elements. A single unit may fulfil the functions of several items recited in the disclosure, and vice versa several items may fulfil the function of one unit.

The mere fact that certain measures are recited in mutually different dependent claims does not indicate that a combination of these measures cannot be used to advantage. Multiple alternatives, equivalents, variations and combinations may be made without departing from the scope of the invention.

1. Substrate punch assembly, comprising
a punch for perforating a substrate,
a resilient element provided next to the punch, and
a die arranged opposite to the punch for pressing against the substrate in the direction of the punch during a punch action, wherein
the resilient element is configured to at least partly move with respect to the punch for pushing the substrate away from the punch when the punch moves away from the die.

2. Substrate punch assembly according to claim 1, wherein the resilient element comprises elastomeric material.

3. Substrate punch assembly according to claim 1, wherein the resilient element is arranged around the circumference of the punch.

4. Substrate punch assembly according to claim 1, wherein the punch is arranged to have a velocity vector parallel to the velocity vector of the substrate at a point of perforation.

5. Substrate punch assembly according to claim 1, wherein
the punch comprises a rotary punch that is configured to rotate around a rotation axis so that it moves in approximately the same direction as the substrate when the substrate moves along the punch during perforation, and
the rotation axis extends perpendicular to a substrate movement direction.

6. Substrate punch assembly according to claim 1, further comprising a drive mechanism configured to drive the punch at a variable speed dependent of preset distances between subsequent perforations in the substrate.

7. Substrate punch assembly according to claim 1, wherein the die comprises a hole for receiving the punch.

8. Substrate punch assembly according to claim 1, wherein the punch comprises an undercut near a cutting edge of the punch.

9. Printer comprising a substrate punch assembly according to claim 1.

10. Printer according to claim 9, comprising
a substrate guide mechanism for guiding the substrate along a substrate path, wherein the substrate path comprises a curved portion, and
the punch is arranged near the curved portion of the substrate path for punching a curved portion of the substrate.

11. Method of punching a substrate, comprising
moving a substrate for printing,
punching the substrate with a punch,
compressing a resilient element against the substrate, and
retracting the punch from the substrate while the resilient element pushes the substrate away from the punch by expanding back to its original size.

12. Method according to claim 11, further comprising
printing the substrate, and
outputting a perforated printed substrate.

13. Method according to claim 11, further comprising curving the substrate and punching the substrate at the curved portion of the substrate.

14. Method according to claim 11, further comprising rotating the punch.

15. Print system, comprising
a substrate guide mechanism for guiding the substrate along a curved path,
a punch for punching a perforation in a curved portion of the substrate, and
a die for receiving the punch,
wherein the punch comprises a resilient element arranged to push the substrate in the direction of the die adjacent to the perforation.
